(19) United States
(12) Patent Application Publication
(10) Pub. No.: US 2005/0133533 A1
(43) Pub. Date: Jun. 23, 2005

(54) Package for photographic processing chemicals

(75) Inventors: Ralf Wichmann, Gladbach (DE); Gustav Tappe, Leverkusen (DE); Tibor Candel-Delic, Leverkusen (DE); Boze Marsic, Leverkusen (DE)

Correspondence Address: CONNOLLY BOVE LODGE & HUTZ, LLP, P O BOX 2207, WILMINGTON, DE, 19899, US

(73) Assignee: AgfaPhoto GmbH, Leverkusen (DE)

(21) Appl. No.: 11/019,055

(22) Filed: Dec. 21, 2004

(30) Foreign Application Priority Data
Dec. 22, 2003 (DE) DE 103 60 366.2

(51) Int. Cl. B67D 5/60

(52) U.S. Cl. 222/145.5

(57) ABSTRACT

A package for storing photographic processing chemicals and for filling a tank of a processing apparatus with the processing chemicals, which package contains at least two different chemicals spatially separated in chambers, characterized in that the chemicals belong to the same processing step and the package is constructed such that the various chemicals are brought into contact with one another within the package before the tank is filled with them and/or are brought into contact with one another while the tank is filled with them, is distinguished in that it offers the handling advantage of one-component concentrates without the disadvantages thereof and leads to a better reproducibility of the processing compared with the known multi-component formulations.

The invention relates to a package for storing photographic processing chemicals and for filling a tank of a processing apparatus with the processing chemicals, the package containing at least two different chemicals separated spatially in chambers, in particular such a package for two- or multi-component bleach-fixing bath concentrates. The invention also relates to a process for processing photographic materials in which such packages are used, a process for the production of such packages and the use of such packages.

In the context of the invention, photographic processing chemicals are understood as meaning chemical substances or formulations of Such substances which can be used for processing recording materials, in particular recording materials containing silver halide. In the following, the recording materials are also called photographic materials and include all materials which can be exposed to actinic radiation, that is to say e.g. to light or UV, IR or X-ray radiation and, after chemical processing, give a recording which can be detected or read visually or mechanically.

For processing of photographic materials, the baths used, such as e.g. developer bath, bleaching bath, fixing bath, bleach-fixing bath or stabilizing bath, are initially prepared as tank solutions. However, during the processing these are consumed by chemical reaction and by material carried in and over, depending on the material throughput. Various methods are employed to compensate for this. All have the same feature that additional processing chemicals must be fed to the process. Preprepared formulations, often concentrated solutions, are conventionally used both for the first tank preparation and for the replenishment.

The pre-prepared formulations for the replenishment are conventionally supplied as concentrates and called replenisher or refill concentrates. As a rule, they are added not directly to the processing tank but into a reservoir tank of the processing apparatus, where they are diluted with water to the desired concentration. These reservoir tanks are also called replenisher tanks and the solution therein is called replenisher solution or simply merely replenisher.

By metering the replenisher solutions into the appropriate processing tanks with a replenishment rate (ml of solution per m² of processed material) which is either fixed and predetermined by the apparatus or manually variable, the processing solutions are always kept at the activity according to type and in principle can be used continuously without interruption.

DE 199 64 300 discloses a package which comprises the replenishing bottles of chemicals for an automatic photographic processing apparatus in a carton. Such a package ensures rapid docking to the apparatus without mistakes, but this is possible only with particular processing apparatuses equipped for this purpose. Such packages comprise the replenishing chemicals not only for one but for all replenisher tanks, and on removal the solutions are led via hoses directly into the particular tanks and therefore come into contact with one another for the first time in the tank.

It is moreover known to provide photographic processing replenishing solutions as one-component solutions or concentrates or, in order to avoid reactions between the chemicals, as multi-component solutions or concentrates.

Both one-component and multi-component concentrates are thus commercially available e.g. for use as bleach-fixing bath replenishing solution. Bleach-fixing baths are predominantly employed for processing photographic colour negative silver halide paper, such as e.g. Agfa type 11, in order to oxidize (bleach) the silver formed during the colour development.

EP 1 209 520 and U.S. Pat. No. 6,221,570 disclose one-component bleach-fixing bath concentrates. However, these have the disadvantage that an oxidizing agent, such as e.g. iron(III)-ethylenediaminetetraacetic acid (iron(III)-EDTA), and a reducing agent, such as e.g. sulfite, are contained in one and the same concentrate and therefore react chemically with one another. During this reaction the sulfite is oxidized to sulfate and the iron(III)-EDTA is reduced to iron(I)-EDTA. During long storage times or long shipment times, this chemical reaction can proceed virtually to completion, so that the majority of the sulfite is converted into sulfate and only a very small amount of sulfite is still present on preparation of the replenisher solution. The storage life of the concentrate and of the replenisher prepared therefrom is thereby reduced significantly. Another disadvantage arises from the fact that during relatively long storage times the iron(III)-EDTA is also reduced to iron(II)-EDTA by other processes. After preparation of the replenisher from the concentrate, only a small amount of the iron required for the bleaching is therefore present as iron(III)-EDTA, as a result of which bleaching problems arise when the tank solution is freshly prepared or if the paper throughput is high. Another disadvantage of using one-component bleach-fixing baths is the fact that by the reaction of sulfite and iron(III)-EDTA to give sulfate and iron(II)-EDTA, the solubility in the concentrate is impaired significantly. Heavy precipitates of crystals of ammonium-iron(II)-EDTA can therefore arise, which can no longer be dissolved and mean that the concentrate becomes unusable and can no longer be used. Because of the disadvantages described for one-component bleach-fixing baths, these have not hitherto been able to find acceptance on the market.

To avoid the said problems with one-component concentrates, two- or three-component formulations of different composition filled in separate containers are therefore often used for the replenishing. Thus e.g. commercially available bleach-fixing bath replenishing solutions comprise two to three concentrates, one concentrate containing the bleaching agent and a second concentrate the fixing agent. A third concentrate can contain an acid for adjustment of the pH, but the acid can also be contained in one of the concentrate components for the bleaching agent or the fixing agent, so that in this case only two concentrate components are necessary.

When the known multi-component replenishing concentrates are used, in spite of their high storage life there are still problems with reproducibility, which manifests itself in the fact that the action of the processing baths prepared with these can vary from preparation to preparation, even if the replenishing solutions originate from the same production batch. This undesirable effect, through which the quality of the processed photographic materials is impaired, is furthermore of widely varying degree, depending on the processing apparatus and on the operating staff, and can even lead to completely unusable processing results, as a result of which the recording is irretrievably lost in the case of originals.

The known packages for photographic processing chemicals are unsatisfactory for the reasons mentioned.

The invention is therefore based on the object of providing a package for photographic processing chemicals which avoids the disadvantages mentioned for the known embodiments and which in particular functions on conventional processing apparatuses without additional installations, does not have the stability disadvantages of one-component formulations and leads to a better reproducibility of the processing.

It has been found, surprisingly, that this is achieved with a multi-chamber package which contains photographic processing chemicals, the chemicals coming into contact with one another before and/or during removal and before reaching the tank. Even for multi chamber packages according to the present invention, that are more elaborate with regard to their manufacture than conventional containers, the possibly higher expense is more than compensated by the advantages of the present invention.

The invention therefore provides a package for storing photographic processing chemicals and for filling a tank of a processing apparatus with the processing chemicals, the package containing at least two different chemicals spatially separated in chambers, characterized in that the chemicals belong to the same processing step and the package is constructed such that said different chemicals are brought into contact with one another within the package before the tank is filled with them and/or are brought into contact with one another while the tank is filled with them (during removal).

Preferably, the various chemicals come into contact with one another during removal in order to reliably avoid the known problems described above for one-component formulations. In this context, the contact can take place within and/or outside the package. Preferably, the contact takes place directly at the removal opening of the package.

In the following, a package according to the present invention is also called a multi-chamber package, and in a preferred embodiment also a multi-chamber bottle, and is to be understood as a fixed unit which is maintained as a unit in respect of the chambers during shipment and during conventional use by the customer. It can additionally be packed with the known materials. The multi-chamber package has at least one removal opening which is provided with a closure. For the removal, the closure must be opened, it being possible for the closure in the opened state to continue to be connected to the multi-chamber package, as is the case e.g. with a hinged closure, or to be separated from the package, as is the case e.g. with a screw closure. The closure or a part thereof can also be penetrated for opening, and the various closure types can also be combined with one another. Since the contents of the multi-chamber package are conventionally removed as a whole, it no longer has to be closable after the first opening. However, a possibility of reclosing may be appropriate in order to prevent discharge of residues of chemicals on disposal.

The photographic processing chemicals in the context of the invention are the replenishing chemicals necessary for a processing step, depending on the multi-chamber package, replenishing chemicals being understood as meaning both the chemicals for a new preparation of the processing tank solution and the chemicals for preparation of the replenisher tank solution. These can be the pure chemical compounds themselves or suitable formulations, but concentrated formulations of the chemicals (concentrates) are usual. The present invention is suitable for any processing step of any photographic processing process for which at least two different replenishing chemicals can be employed in separate formulations.

It has been found that a better reproducibility of the processing results can only be achieved if the various chemicals of a multi-chamber package come into contact with one another before removal and/or during removal and before reaching the tank. This is the case in particular when refilling the replenisher tank solutions using concentrates.

Without knowing the precise mechanism, it is assumed that this contact in a premix has the effect of preventing inhomogeneities of the distribution of chemicals in the processing apparatus. Thus e.g. when the known multi-component concentrates are used in minilabs, a replenisher solution is usually prepared directly in the replenisher tank. For the preparation, water is initially introduced into the tank and the concentrates required for this are then added. If the concentrates are added individually in succession, as is conventional, formation of layers of the concentrates in the replenisher tank may occur, which can be eliminated only by intensive thorough mixing. Nevertheless, in many minilabs only a type of paddle is provided for the thorough mixing, for reasons of cost and space, as a result of which an intensive thorough mixing takes a very long time. In the context of the present invention, it has been found that even if long mixing times are specified, these are often not adhered to by the staff in order to save time, and it also happens that the replenisher solution is not thoroughly mixed at all after the preparation. If inadequately thoroughly mixed replenisher solution is used, chemicals of different concentration and different composition are metered into the processing solution in the course of processing, which explains the poor reproducibility of the processing and therefore the varying quality of the processed material. Surprisingly, this disadvantage can be counter-acted with the multi-chamber package. It has been found that the necessary mixing times can be reduced considerably in this way, and if particularly suitable packages according to the invention are used, subsequent mixing can even be dispensed with entirely.

In the context of the present invention, it has been found that when the known multi-component concentrates are used, unsatisfactory and non-reproducible processing results are also thereby obtained, that one concentrate component is either forgotten completely or that e.g. instead of component A and component B two components A are used. In both cases the processing solution becomes unusable and photographic materials processed with this are often lost forever. Furthermore, it may happen that concentrates from various production times are mixed with one another during preparation, e.g. a new batch of component A and an old batch of component B being mixed. This can lead to stability losses and deviations in pH in the ready-to-use solutions, and brings about an undefined state, since no producer of processing chemicals can test all the possible combinations of concentrates of different age in respect of their actions and secondary actions during processing. In addition, a component of one batch can remain unused again and again in this way and as a result age severely. The damage is particularly high if the storage life of the old batch has already expired, that is to say this is no longer capable of use, and the mixture prepared from this and a new batch becomes unusable. Precisely in recent years has the workload of the operating staff, that often only is semiskilled, increased more and more, which combined with the complexity of the operation explains why claims for compensation occur to an increasing extent in the case of non-automated replenisher preparation and illustrates how important it is to increase operating reliability. Since according to the present invention the individual concentrates are combined in one package, it is no longer possible to make mistakes between them and all the concentrates of such a multi-chamber package have the same production time and have experienced the same storage conditions. In addition it cannot happen, that a given order of addition or a given time schedule for the addition are not adhered to and it cannot happen, that e.g. there is such a long time lapse between the addition of part A and part B, that in the meantime the processing tank is only replenished by part A.

At the same time, the logistics of ordering and warehousing are simplified and handling is considerably more rational compared with the conventional multi-component concentrates with several bottles.

Contact in the context of the present invention is to be understood as any touching of the chemicals or chemical formulations before they reach a tank of a processing apparatus or e.g. a processing dish.

The contact before removal is conventionally established shortly before the use of the package and requires handling or a mechanical operation. In this variant, the point in time of the contact must be chosen shortly before the removal such that the disadvantages known for one-component formulations do not yet arise. This can be recognized by the fact that during the contact time precipitates do not occur and the activity and storage life of the processing chemicals for the photographic processing are not substantially reduced. In this embodiment of the present invention, the contents of the package are preferably mixed e.g. by shaking after the contact and before the removal.

The contact can take place e.g. during the removal on pouring out outside the package if the two streams of chemicals meet there; it can take place before and/or during the removal in a mixing device, also called an adapter in the following, which is part of the package or is attached to the package; and it can take place before the removal in the package, e.g. in that a separating device between the chambers is removed or penetrated. The possible embodiments of the present invention which are mentioned as examples can also be combined with one another if the package is constructed such that e.g. the chemicals from two chambers come into contact before the removal and this mixture comes into contact with a chemical from a third chamber during the removal.

The multi-chamber package without the processing chemicals is also called a multi-chamber container in the following, regardless of whether or not it comprises the closure.

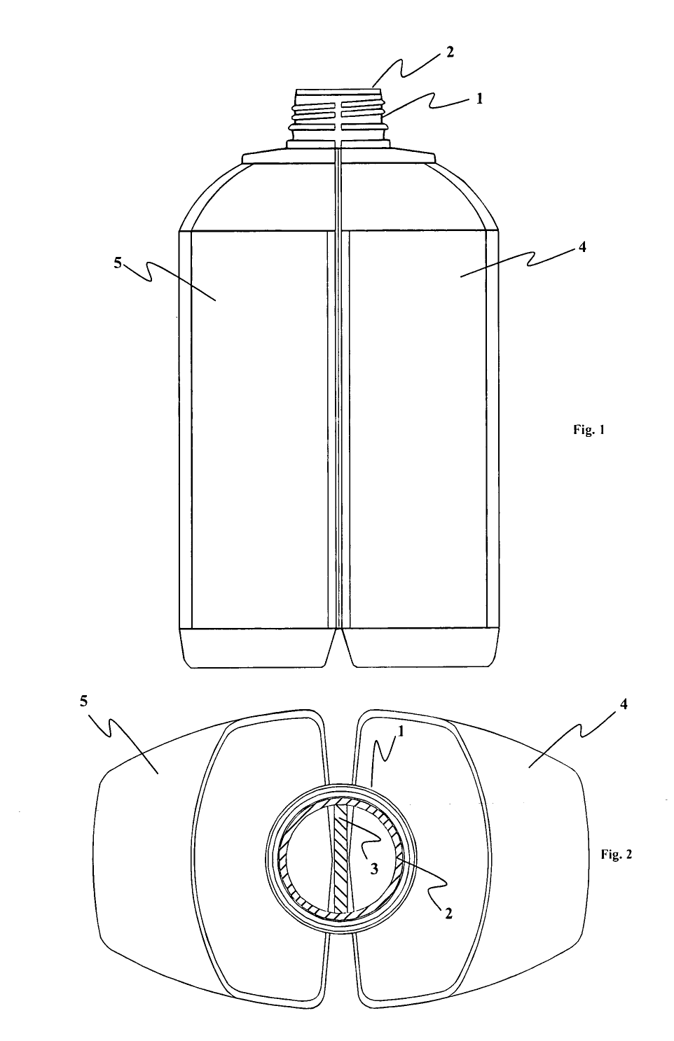

A preferred embodiment of the multi-chamber container, which is a two-chamber bottle, is shown in FIGS. 1 and 2. In FIG. 1, the two-chamber bottle is shown in front view and has a bottle neck (1), with a thread which ends in an area (2) plane-parallel to the bottle base. The bottle has the chambers (4) and (5) which are separated from one another. In the view from the top according to FIG. 2, in addition to the abovementioned features a connecting bridge with an upper closing area (3) can be seen, which joins the chambers at its lower end and separates them from one another continuously up to the edge (2). By a closure which seals off the areas (2) and (3) in the closed state, it can thus be ensured that the contents of the chambers (4) and (5) do not come into contact with one another before removal.

When a two-chamber package of the abovementioned two-chamber bottle and the particular processing chemicals was used, it was found, completely surprisingly, that the reproducibility of the processing results can even depend on how the bottle is held during emptying. Although the advantages of the invention are achieved independently of how the bottle is held, the reproducibility is on average better if the bottle is held such that the longer edge of the connecting bridge and therefore also the upper closing surface (3) thereof run horizontally during pouring out, as a result of which the chambers (4) and (5) are arranged not side-by-side but one above the other.

The multi-chamber container is preferably constructed such that a good thorough mixing is ensured as far as possible directly behind the removal opening (in the following also called pouring opening, discharge opening, spout or discharge) and during removal is preferably held such that this is promoted.

The preferred handling can be influenced by the shape of the bottle, in that e.g. handles, holding indentations or holding bulges are arranged on the package such that when these holding aids are used the best possible thorough and reproducible mixing takes place. The handle can be constructed such that it holds together and/or stabilizes the chambers. In a further embodiment of the multi-chamber package, a handle can be fixed thereto, in particular latched in. Furthermore a holding aid results in the known advantages, in particular save handling during transport and during removal (emptying).

The bottle according to FIGS. 1 and 2 is an example of a preferred embodiment of the multi-chamber container in which at least two and in particular all the chambers have a common closable removal opening, which renders possible immediate contact directly at the spout, and in a horizontal arrangement of the connecting bridge in the spout the concentrates evidently flow into one another directly, instead of at least initially flowing side-by-side in the vertical arrangement. Further advantageous embodiments of the multi-chamber container which ensure good thorough mixing shortly before or during the removal are described in the following, without the invention being restricted thereto.

The package according to the invention can comprise two, three, four or also more than four chambers; it preferably comprises two or three and it particularly preferably comprises two chambers.

To keep the expenditure on production as low as possible, only as many chambers as are necessary to achieve the advantages of the invention are used. The expert can often be guided by the known multi-component concentrates in order to discover a suitable division of a concentrate for the multi-chamber package. However, the division can also preferably be optimized specifically for the package according to the present invention, e.g. in that the number of components is reduced in order to lower the production costs for the multi-chamber package or in that the volumes of the components are adjusted such that the contact which takes place before and/or during the removal leads to a thorough mixing which is as intensive as possible.

Although the individual chambers of the multi-chamber vessel can occupy any desired volume independently of one another, for the thorough mixing it has proved favourable if the capacities of the individual chambers do not deviate too greatly from one another.

In a preferred embodiment of the multi-chamber package, the ratio (Qᵥₒₗ) between the volume of the largest chamber (Vₘₐₓ) and the volume of the smallest chamber (Vₘᵢₙ)

$${Q}_{vol} = \frac{{V}_{max}}{{V}_{min}} \qquad ( 1 )$$

is therefore not more than 4, in particular between 1 and 2.5. Particularly preferably, all the chambers are about the same size, which means that Qᵥₒₗ is between 1 and 1.2.

The volume of a chamber of the multi-chamber package is understood as meaning the total internal space of the chamber, that is to say both the space filled with processing chemicals and also any residual volume present. For reliable handling, it is furthermore preferable for the package to weigh not more than 20 kg in total, in particular not more than 10 kg. Suitable multi-chamber packages are e.g. two-chamber packages with chamber volumes of 2 times 100 ml to 2 times 5 l, preferably with chamber volumes of 2 times 125 ml to 2 times 3 l, and particularly preferably with chamber volumes of 2 times 250 ml to 2 times 2.5 l.

Optimization of the components of a processing replenishing concentrate in a manner such that they match the multi-chamber packages in terms of volume is known to the expert in the field of photographic processing chemicals and the invention is not limited to a particular type of partitioning.

To save production costs, the chambers of a multi-chamber package preferably contain all the various formulations and are all filled with the formulation to the extent of at least 50 vol. %, in particular to the extent of at least 70 vol. % and particularly preferably to the extent of at least 80 vol. %. The remaining volume of the chambers which is not filled by the formulation is conventionally filled with air or an equilibrium mixture of air and the gases escaping from the formulations. Instead of air, however, they can also contain an inert gas at least in some cases, or the air pressure in the chambers can be reduced. Inert gas in the context of the invention is to be understood as meaning any gas or gas mixture which does not react with the concentrate in the same chamber under the conventional storage conditions. The inert gas is particularly preferably free from oxygen, and is e.g. nitrogen, carbon dioxide or argon.

However, the multi-chamber package can also comprise chambers in which there is no formulation or two or more chambers which contain the same formulation. Chambers which are not used for accommodation of formulations, non-used part volumes and several chambers with the same formulation are avoided if possible, but may be necessary e.g. for stability reasons or for production reasons.

In a preferred embodiment of the multi-chamber package, at least two chambers, preferably all the chambers, have a common closable removal opening and the chambers are separated from one another in the closed state.

In a further preferred embodiment of the multi-chamber package according to the present invention, at least two chambers, preferably all the chambers, have separate openings which are connected to a removal opening with an adapter. In this embodiment it is decisive that the various chemicals do not already come into contact in the adapter during transportation and storage. The adapter can comprise e.g. channels which emerge from the individual chambers and are led separately to a closure at the spout, where they are also sealed off from one another.

If the various chemicals are to come into contact in the adapter during removal, the individual chambers must be closed during transportation and storage and opened only shortly before the removal and before mounting of the adapter. This can be effected e.g. by the adapter simultaneously opening the chambers when mounted on the package, in that it breaks through e.g. an intentional breaking point or a seal and docks at this point. Such an adapter can also comprise elements which promote thorough mixing of the chemicals. Adapters with valves, and in particular those with non-return valves, are also possible.

The multi-chamber package preferably has only one closure, which closes all the chambers, for which any known type of closure is suitable as long as the chambers are thereby sealed off from one another. In particular, the closure can be a stopper, a seal, a hinged lid or a screw closure, and the closure is particularly preferably a screw closure.

A screw closure which is used e.g. for the two-chamber container according to FIGS. 1 and 2 can be sufficient, merely by shaping and choice of the materials alone, to seal off the package according to the invention, but it preferably comprises an insert, e.g. in the form of a sealing ring of relatively soft or relatively flexible material which is resistant to chemicals and allows a reliable seal.

A hinged lid is preferably part of a closure device which is pushed over the pouring connector or connectors of the chambers and is fixed there by positive locking, e.g. by catching. By pushing the closure device on, the chambers are simultaneously stabilized and held together.

In a particularly advantageous embodiment of the present invention, the chambers of the package are also separated from one another in a gas-tight manner. This avoids volatile constituents of the various chemicals coming into contact with one another during transportation and storage. This can be achieved with known closure types, but it is particularly advantageously achieved with a seal attached to the neck of the bottle which seals off all the chambers simultaneously and is pulled off or penetrated before the removal. In the bottle according to FIGS. 1 and 2, the seal is attached e.g. such that it seals off the areas (2) and (3) and therefore also the chambers (4) and (5). The seal can be e.g. glued or welded on or shaped and welded from the bottle material itself. The seal particularly preferably comprises a suitable film, in particular of aluminium-laminated polyethylene, and in particular is permanently connected to the multi-chamber container opening by high-frequency welding.

The multi-chamber package according to the present invention can be made of all the known materials which are resistant towards the solutions used. However, to render possible a low weight, it is preferable if the package is made predominantly of plastic, and in particular if it is made entirely of plastic. Plastic packages furthermore are very resistant to fracture and, compared with other materials, can be shaped more easily during production. Suitable plastics are all the shapable plastics which are conventionally employed e.g. for the production of plastic bottles. Plastics which are particularly suitable for the multi-chamber package are polyethylene (PE), polypropylene (PP), polyethylene terephthalate (PET) or polyvinyl chloride (PVC); mixtures thereof; or copolymers of the monomers on which the polymers mentioned are based. To facilitate disposal, the packages are preferably produced from plastics of a pure variety, in particular from PE, PP or PET. Recycled plastic can also advantageously be used.

Multi-chamber packages of glass can in principle also be employed, but because of their fragility and the high weight they are less suitable than those of plastic.

The advantages according to the invention can already be achieved by separate containers which are connected mechanically to form a package, e.g. in that they are held together in packaging, in particular a carton, or e.g. by suitable integrated interlocking profiles or clamping devices, or in that they are joined permanently e.g. with a shrink-film and/or an adhesive film and/or an elastic and/or a resilient material. They are particularly advantageously held together with an adhesive label, which is also required for the warnings and use instructions.

Independently of whether separate containers or permanently connected chambers are used, it is preferable if the bottle necks of the individual containers or chambers are arranged and constructed respectively unsymmetrically such that the individual bottle necks come as close as possible. As a result, e.g. a closure can simply be screwed on or pushed on. For two-chamber containers, an embodiment corresponding to FIGS. 1 and 2 in which the necks of the two chambers merge in a circular screw thread is particularly preferred. This embodiment can be realized e.g. with separate containers or bottles which each have a semi-circular bottle neck on the outer edge of the bottle and are joined to one another with an accurate fit. The accurately fitting join can be achieved here e.g. by the contact surfaces of the bottles comprising features such as a groove and rib or generally a depression on one surface and elevation on the adjacent surface, which engage in one another with an accurate fit.

In an advantageous embodiment of the invention, on the other hand, the chambers are permanently joined to one another physicochemically and/or chemically. A physicochemical join is to be understood e.g. as a gluing based on adhesion, and a chemical bonding is to be understood as meaning e.g. a gluing based on a chemical reaction, fusing together of the container parts or production of the container parts as one unit which is continuous in itself. It is particularly preferable to produce the container parts as one unit which is continuous in itself by producing the multi-chamber container e.g. in the extrusion blow moulding process with a mould in one step or in combination with a separate second step in the injection moulding process. In this procedure, it is possible also first to produce only one large chamber as a moulding blank, from which the required number of chambers is then obtained in the following shaping step. FIGS. 1 and 2 show such a two-chamber container produced in the extrusion blow moulding process. The containers can additionally be stabilized by also joining the chambers, which are permanently joined in this case, with a shrink-film or adhesive film. It is particularly advantageous to join the chambers with an adhesive label. A large label area for the required instructions and at the same time a higher stability of the multi-chamber container are obtained in this way.

Multi-chamber containers, in particular two-chamber bottles, which comprise at least two container parts with pouring connectors and which are shaped in one piece from plastic and the container parts of which are joined to one another via a connecting bridge which runs approximately parallel to the axial extension of the container parts and which at the same time forms the dividing wall between the separate chambers of the container are particularly preferred. Each container part can be connected to the adjacent container part(s) on both sides of the axial connecting bridge via at least one substantially radially running bridge-like reinforcement.

The radial reinforcing bridges of the container parts impart to the multi-chamber container a greater rigidity. In particular, tilting or swivelling of the container parts around the axial connecting bridge is thereby prevented. As a result of the increase in container rigidity due to the construction, the wall thickness of the container parts can be reduced, which has an advantageous effect on the production costs of the multi-chamber container.

A construction of the multi-chamber container which is particularly rigid to tilting, even with a reduced wall thickness of the container parts, results if the radial reinforcing bridges are joined to the axial connecting bridge.

The particularly preferred multi-chamber container having at least two similar container parts which are joined to one another via an axial connecting bridge and have pouring connectors which together form a container neck is advantageously produced by the extrusion blow moulding process. The extrusion blow moulding process is tried and tested and allows inexpensive mass production of the one-piece multi-chamber container of plastic in large piece numbers. In this procedure, a parison is introduced into a blow mould equipped with separate mould chambers corresponding to the production and joining of the container parts and is inflated, by means of a gas blown in under increased pressure, via a blow mandrel introduced into the blow mould. The parison, which is usually prepared from molten granules of plastic, can be in various forms. For example, it can be constructed as a tube or can have a longitudinal, cylindrical shape. The parison is introduced into the cavity of a blow mould immediately after its preparation or also only at a later point in time and is inflated according to the mould cavity and is thereby shaped to its final form.

As an alternative to the one tube process described above it can also be started from two or more parisons, that are formed concurrently and closely adjacent to each other. Each of said parisons constitutes the preliminary stage for a chamber and in the blow process said parisons are reshaped to the final multi-chamber container. This more elaborate manufacturing process is advantageous, in that the dividing wall that is in common for two chambers respectively is made of two layers in this case, what results in an increased mechanical stability and leak proof.

Multi-chamber containers having three, four or more separate chambers can be constructed and produced in a manner analogous to that described for the two-chamber container. In this context, the individual bottles can be arranged e.g. in a row or concentrically, but they are preferably arranged like pieces of cake (3 segments each of 120° in a three-chamber bottle) and the necks of the individual bottles or chambers complement each other to form a preferably circular neck of the multi-chamber package. The boundary surfaces of the chambers continue in the neck in a bridge, as described above for the two-chamber bottle according to FIGS. 1 and 2.

For a three-chamber container, the bridge divides the neck into 3 passages, for a four-chamber bottle into four etc.

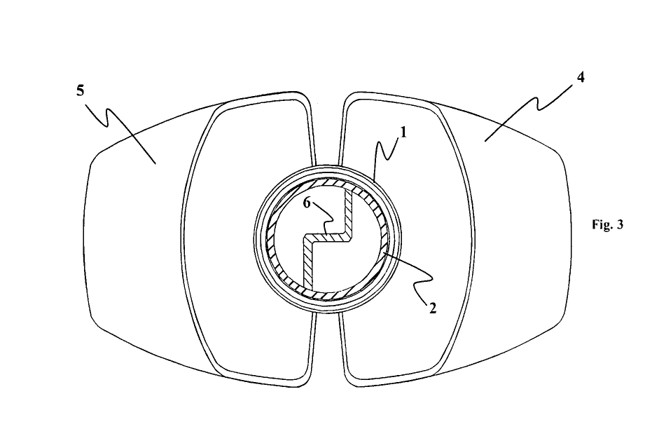

Further advantages can be achieved with a multi-chamber container similar to the one according to FIGS. 1 and 2, if instead of the straight (linear) connecting bridge according to FIG. 2 a non-linear connecting bridge is provided, e.g. in curved, step, S- or Z-form. Such a non-linear connecting bridge, a particular preferred embodiment of which is shown as (6) in FIG. 3, works as a forced mixer, gives a particular high reproducibility and minimises the influence of the handling of the container on emptying. Multi-chamber containers with non-linear connecting bridges have similar mixing properties as containers with an appropriate adapter, but might be more elaborate in production than those with an adapter. Nevertheless they can be advantageous, if e.g. from technical reasons, on demand of the customer or because of the required place the use of an adapter is not possible or unwanted.

Part amounts can indeed also be removed from the multi-chamber container, but it is preferable to empty a multi-chamber container completely during one removal. This renders possible a larger passage through the neck of the bottle compared with the passage which would be permissible for accurate metering. It has been found that a larger passage cross-section is favourable for the thorough mixing. Preferably, the passage cross-section at the bottle neck for at least one chamber is at least 50 mm², in particular at least 150 mm² and particularly preferably at least 250 mm². Further advantages are achieved if all the chambers of the multi-chamber container have such a cross-section. Larger passage cross-sections furthermore facilitate filling of the multi-chamber containers.

The processing chemicals can be contained in the multi-chamber packages as liquids, solids or mixtures thereof, in particular as solutions, pastes, powders, granules or dispersions, as suspensions or emulsions. The chemicals are either contained in the chambers in a flowable form, or they can be converted into a flowable state by operations before the removal. Suitable operations can be e.g. shaking, or that at least 2 chambers are connected to one another and mixed thoroughly before the removal. Preferably, the multi-chamber package contains concentrated solutions of the processing chemicals.

In a particularly preferred embodiment of the present invention, the multi-chamber package contains the chemicals for a two- or multi-component bleach-fixing bath concentrate. The known packages are particularly unsatisfactory for this processing step, and it has been found that the problems described above in respect of poorly reproducible processing results can be greatly reduced if a multi-chamber package is used for replenishing the bleach-fixing bath replenisher solution. This advantage is particularly pronounced in the processing of colour photography silver halide materials, in particular copying materials having a silver chloride content of at least 95 mol %, based on the total silver halide in the material, and occurs to the greatest extent with short bleach-fixing times of 10 to 130 seconds, in particular 15 to 90 seconds and especially 20 to 60 seconds.

Particularly good results can be achieved with a multi-chamber package in which the bleaching agent and the fixing agent are contained in separate chambers and in particular in each case as a concentrate.

In particular, compared with the known one-component bleach-fixing bath concentrates an increased self-oxidation of the concentrate can be thereby avoided, as a result of which the storage life both of the concentrate itself and of the replenisher tank solution (replenisher) prepared therefrom is improved considerably.

It is moreover possible to prepare a more highly concentrated formulation and thereby to save transportation and storage costs, without precipitates occurring.

In a preferred embodiment, the multi-chamber package comprises 2 chambers, the one containing a concentrate with a bleaching agent which comprises an Fe(III) complex salt, such as e.g. iron(III)-EDTA or iron(III)-EDDS, and a buffer substances, such as e.g. acetic acid, imidazole, phosphoric acid or dicarboxylic acids or salts thereof. The other chamber contains a concentrate with a fixing agent, preferably thiosulfate, in particular ammonium thiosulfate, and advantageously additionally a stabilizing agent for the fixing agent, e.g. a sulfite salt. The two concentrates can additionally comprise nitrate or bromide.

Fe(III) complex salts which are suitable for photographic bleaching and bleach-fixing baths are known from a large number of documents (e.g. EP 329 088, 584 665, 507 126, 556 782, 532 003, 750 226, 657 777, 599 620, 588 289, 723 194, 851 287, 840 168, 871 065, 567 126, 726 203 and U.S. Pat. No. 5,670,305).

Preferred complexing agents for Fe(III) are: ethylenediaminetetraacetic acid (EDTA), propylenediaminetetraacetic acid (PDTA), β-alaninediacetic acid (ADA), diethylenetriaminepentaacetic acid (DTPA), methyliminodiacetic acid (MIDA), ethylenediaminemonosuccinate (EDMS), methylglycinediacetic acid (MGDA), ethylenediaminedisuccinate (EDDS), specifically (S,S)-EDDS, iminosuccinic acid, iminosuccinic acid-propionic acid and 2-hydroxypropyliminodiacetic acid, and a preferred bleaching agent comprises at least one iron complex with one of the complexing agents mentioned.

Mixtures of complexing agents can also be employed, and between 0.15 to 1.5 and preferably between 0.2 to 1.2 and particularly preferably 0.3 to 0.9 mol/l of Fe(III) complexing agent are employed in the concentrate.

In addition, bleaching accelerators, such as e.g. 3-mercapto-1,2,4-triazole or thioglycerol, can also be employed.

Further constituents of the concentrates can be e.g. aminopolycarboxylic acids, rehalogenating agents, acids and alkalis to adjust the pH, bleaching accelerators, white couplers and buffer substances (see Research Disclosure 37 038, February 1995, pages 107 to 109).

Preferred buffer substances, in addition to acetic acid, are dicarboxylic acids, such as e.g. malonic acid, succinic acid or adipic acid, and salts thereof. A buffer substance can be contained both in the chamber with the bleaching agent and in the chamber with the fixing agent.

The pH in the concentrate which comprises the bleaching agent is 1 to 9, preferably 2 to 8 and particularly preferably 2.5 to 7.5.

Phosphates which can be employed are the alkali metal salts and/or ammonium salts, e.g. ammonium dihydrogen phosphate, di-ammonium hydrogen phosphate, tri-ammonium phosphate, potassium dihydrogen phosphate, di-potassium hydrogen phosphate, tri-potassium phosphate, sodium dihydrogen phosphate, di-sodium hydrogen phosphate and tri-sodium phosphate.

Alkali metal and/or ammonium nitrates and bromides can be employed as the nitrates and bromides.

The phosphates, nitrates and bromides are preferably added to the concentrate in an amount of 0.1 to 2.0 mol/l, in particular 0.2 to 1 mol/l.

Suitable fixing agents are, in particular, sodium, potassium and especially ammonium thiosulfate. In addition, sodium, potassium and ammonium thiocyanate can also be employed as a fixing agent. Fixing accelerators, such as e.g. imidazole, can additionally be employed.

Suitable sulfite salts are e.g. ammonium sulfite, ammonium hydrogen sulfite, sodium sulfite, sodium disulfite, sodium hydrogen sulfite, potassium sulfite, potassium disulfite and potassium hydrogen sulfite. Suitable sulfinic acids are e.g. hydroxymethanesulfinic acid, formamidinesulfinic acid, benzenesulfinic acid, p-toluenesulfinic acid, methanesulfinic acid, o-amidosulfinic acid and salts thereof.

Other complexing agents, individually or in a mixture, can also additionally be added to the concentrates. Complexing agents which are preferred for this are polycarboxylic acids, such as e.g. oxalic acid, malonic acid, glutaric acid, adipic acid, suberic acid, fumaric acid, maleic acid, itaconic acid or phthalic acid. Polyhydroxy-polycarboxylic acids, such as e.g. citric acid, glycolic acid, lactic acid, malic acid, tartaric acid or galactaric acid, are also preferred.

After opening and emptying of the package, the two concentrates of the package come into contact with one another directly after the spout and are then conventionally diluted with water in the ratio of 1:1 to 1:20, preferably in the ratio of 1:2 to 1:15 and particularly preferably 1:3 to 1:12. The concentrates can also be employed in undiluted form after opening and emptying of the package.

The multi-chamber package for a bleach-fixing replenishing solution can also contain a third concentrate which comprises e.g. an acid, such as e.g. acetic acid, succinic acid, phosphoric acid, nitric acid or sulfuric acid, with which the pH in the replenisher tank of the bleach-fixing bath solution can be adjusted. However, the acid is preferably contained in the chamber for the bleaching agent and/or the chamber for the fixing agent, so that in this case only two concentrate components are necessary.

In a preferred embodiment of the present invention, not only are the chemicals for one processing step replenished with a multi-chamber package, the chemicals required for at least one further processing step are also replenished with a multi-chamber package. If a multi-chamber package for replenishing the bleach-fixing chemicals is employed as described above, it is advantageous e.g. also to use a multi-chamber package for replenishing the colour developer chemicals.

To surely prevent also the mix-up with chemicals for different processing baths, the multi-chamber packages can be provided with features that easily and unambiguously identify the processing step, the package is designed for. This can be done e.g. by a color labelling at the package, that matches with a corresponding labelling at the feed opening of the processing tank. Even more save is a form of the removal opening of the package and correspondingly of the feed opening of the processing tank in a way, that only the appropriate package can be filled in the processing tank. This can be achieved, e.g. by the form of the outer shape of the removal opening that fits to the inner shape of the feed opening and is possible e.g. by various geometrical forms like circles, rectangles, grooves and so on.

Colour developers are used in the development of colour photography silver halide materials. In the colour developer solutions, the silver halide is reduced to metallic silver at the exposed points of the emulsion layers of the material. The oxidation products of the colour developer which are formed during this operation react with the colour couplers contained in the emulsion layers to form yellow, magenta and cyan image dyestuffs. At the same time as the black-and-white images, dyestuff images are thus formed, which remain when the metallic silver is bleached and removed during the subsequent processing. The removal of the metallic silver is carried out predominantly in a bleach-fixing bath in the processing of colour negative paper, and predominantly in a bleaching bath and a subsequent fixing bath in the processing of colour negative films.

Three different concentrates are conventionally used for the preparation of colour developer solutions, since certain constituents of the developer bath are not compatible with one another during a relatively long standing time. Thus e.g. one concentrate comprises the antioxidant, an auxiliary solvent and a whitener, a second concentrate comprises the colour developer substance, e.g. 4-(N-ethyl-N-2-methylsulfonylaminoethyl)-2-methylphenlylenediamine sesquisulfate (CD-3) or 4-(N-ethyl-N-2-hydroxyethyl)-2-methylphenylenediamine sulfate (CD-4), and usually also additionally an antioxidant, and a third concentrate comprises a buffer substance, alkali, a lime prevention agent and optionally an anti-fogging agent.

Particularly good results can be achieved with a multi-chamber package in which the developer substance and the alkali are contained in separate chambers, and in particular in each case as a concentrate.

In particular, compared with the known one-component colour developer concentrates, an increased self-oxidation of the concentrate can thereby be avoided, as a result of which the storage life both of the concentrate itself and of the replenisher tank solution (replenisher) prepared therefrom is improved considerably.

It is furthermore possible to prepare a more highly concentrated formulation and as a result to save transportation and storage costs without precipitates occurring.

In a preferred embodiment, the multi-chamber package comprises 2 chambers, the one containing a concentrate with a colour developer substance, such as e.g. 4-(N-ethyl-N-2-methylsulfonylaminoethyl)-2-methylphenylenediamine sesquisulfate (CD-3) or 4-(N-ethyl-N-2-hydroxyethyl)-2-methylphenylenediamine sulfate (CD-4) and having a pH of less than 7. The other chamber contains a concentrate which has a pH greater than 7 and comprises, inter alia, a buffer and alkali.

The colour developer substance can be added in the concentrate as sulfate, as is customary with CD-3 or CD-4, or also as phosphate, p-toluenesulfonate, chloride or as the free base. However, CD-3 (sesquisulfate) and CD-4 (sulfate) can also be employed and the sulfate ions can be separated off by precipitation with metal ions and filtration.

The colour developer substances are employed in the concentrate in amounts of between 0.04 to 2.3 mol/l, preferably between 0.05 to 2.1 mol/l and particularly preferably between 0.06 to 1.9 mol/l.

The concentrates according to the invention for a colour developer (developer concentrate) also comprise, in addition to the colour developer substance, the conventional chemicals required for development of a colour photography material, in particular antioxidants, solvents, wetting agents, lime prevention agents, whiteners, complexing agents for heavy metal ions, a buffer system, anti-fogging agents and acids or alkalis for adjustment of the pH.

Suitable antioxidants are alkali metal sulfites or alkali metal disulfites, hydroxylamine (HA), diethylhydroxylamine (DEHA), N,N-bis(2-sulfoethyl)hydroxylamine (HADS) and compounds of the formulae (I), (II) and (III): 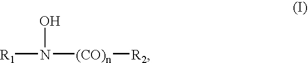
wherein

R₁ denotes optionally substituted alkyl,

R₂ denotes optionally substituted alkyl or optionally substituted aryl and

n denotes 0 or 1,

preferably those in which at least one of the radicals R₁ and R₂ contains at least one —OH, —COOH or —SO₃H group; 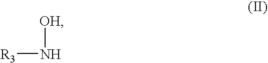
wherein

R₃ denotes an alkyl or acyl group; 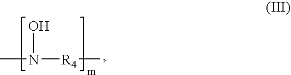
wherein

R₄ denotes an alkylene group which is optionally interrupted by O atoms and

m denotes a number of at least 2.

The alkyl groups R₁, R₂ and R₃, the alkylene group R₄ and the aryl group R₂ can contain further substituents beyond the substitution stated.

Examples of suitable antioxidants are

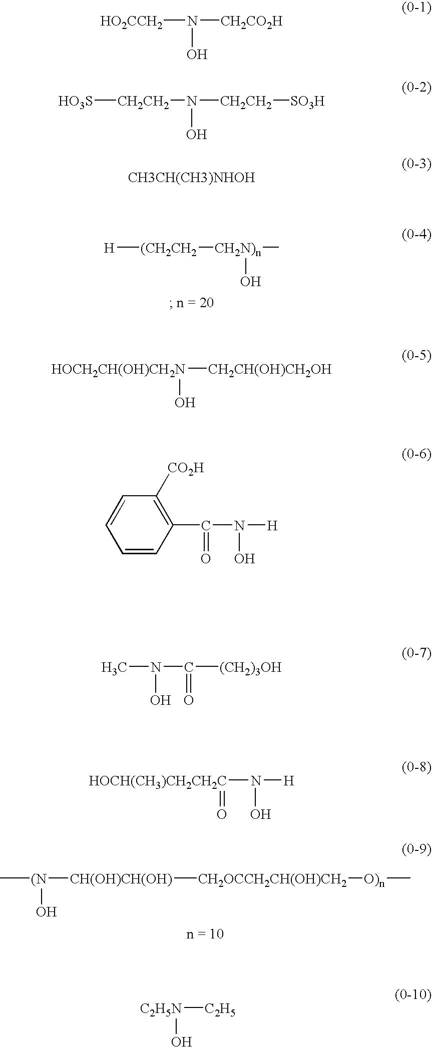

If 4-(N-ethyl-N-2-methylsulfonylaminoethyl)-2-methyl-phenylenediamine sesquisulfate (CD-3) or 4-(N-ethyl-N-2-hydroxyethyl)-2-methylphenylenediamine sulfate (CD-4) is used as the colour developer substance, sulfites, hydroxylamine, diethylhydroxylamine and antioxidants (0-2) are preferred. Particularly preferred antioxidants are hydroxylammonium sulfate, sodium sulfite, potassium sulfite, (0-2) and diethylhydroxylamine.

Combinations of antioxidants or the use of several antioxidants are also possible.

The antioxidants are employed in the concentrate in amounts of 0.1 mmol to 10.0 mol/l, preferably in amounts of 0.5 mmol to 8.0 mol/l, particularly preferably in amounts of 1.0 mmol to 6.0 mol/l.

In a preferred embodiment, the concentrates for processing colour negative papers can comprise one or more water-soluble organic solvents.

In a preferred embodiment for concentrates for processing colour negative papers, the organic solvent comprises a mixture of polyethylene glycols of varying molecular weight from monoethylene glycol to polyethylene glycol having an average molecular weight of 20,000, for example a mixture of diethylene glycol, polyethylene glycol having an average molecular weight of 400 and polyethylene glycol having an average molecular weight of 15,000. The average molecular weights are weight-average.

In particular, the polyethylene glycol mixture makes up at least 90 vol. % of the organic solvent.

Preferred glycols which can be employed are also ethylene glycol, diethylene glycol, triethylenie glycol, tetraethylene glycol, 1,2-propanediol, triethylene glycol monophenyl ether and diethylene glycol monoethyl ether.

In addition to glycols, triethanolamine, triisopropanolamine, caprolactam, propylene glycol or propylene glycol mixtures or p-toluenesulfonic acid or salts thereof can preferably also be employed.

Possible water-soluble organic solvents are those from the series consisting of glycols, polyglycols, alkanolamines, aliphatic and heterocyclic carboxamides and aliphatic and cyclic monoalcohols, 50 to 95 wt. %, preferably 60 to 90 wt. % of the total of water and water-soluble solvent being water.

Suitable water-soluble solvents are e.g. carboxylic acid amide and urea derivatives, such as dimethylformamide, methylacetamide, dimethylacetamide, N,N′-dimethylurea, tetramethylurea, methanesulfonamide, dimethylethyleneurea, N-acetylglycine, N-valeramide, isovaleramide, N-butyramide, N,N-dimethylbutyramide, N-(2-hydroxyphenyl)-acetamide, N-(2-methoxyphenyl)-acetamide, 2-pyrrolidinone, ε-caprolactam, acetanilide, benzamide, toluenesulfonamide and phthalimide;

aliphatic and cyclic alcohols, e.g. isopropanol, tert-butyl alcohol, cyclohexanol, cyclohexanemethanol and 1,4-cyclohexanedimethanol;

aliphatic and cyclic polyalcohols, e.g. glycols, polyglycols, polywaxes, trimethyl-1,6-hexanediol, glycerol, 1,1,1-trimethylolpropane, pentaerythritol and sorbitol;

aliphatic and cyclic ketones, e.g. acetone, ethyl methyl ketone, diethyl ketone, tertbutyl methyl ketone, diisobutyl ketone, acetylacetone, acetonylacetone, cyclopentanone and acetophenone;

aliphatic and cyclic carboxylic acid esters, e.g. triethoxymethane, methyl acetate, allyl acetate, methylglycol acetate, ethylene glycol diacetate, glycerol 1-acetate, glycerol diacetate, methylcyclohexyl acetate, salicylic acid methyl ester and salicylic acid phenyl ester;

aliphatic and cyclic phosphonic acid esters, e.g. methylphosphonic acid dimethyl ester and allylphosphonic acid diethyl ester;

aliphatic and cyclic oxy-alcohols, e.g. 4-hydroxy-4-methyl-2-pentanone and salicylaldehyde;

aliphatic and cyclic aldehydes, e.g. acetaldehyde, propanal, trimethylacetaldehyde, crotonaldehyde, glutaraldehyde, 1,2,5,6-tetrahydrobenzaldehyde, benzaldehyde, benzenepropane and terephthalaldehyde;

aliphatic and cyclic oximes, e.g. butanone oxime and cyclohexanone oxime;

aliphatic and cyclic amines (primary, secondary or tertiary), e.g. ethylamine, diethylamine, triethylamine, dipropylamine, pyrrolidine, morpholine and 2-aminopyrimidine;

aliphatic and cyclic polyamines (primary, secondary or tertiary), e.g. ethylenediamine, 1-amino-2-diethylaminoethane, methyl-bis-(2-methylamino-ethyl)amine, permethyl-diethylenetriamine, 1,4-cyclohexanediamine and 1,4-benzenediamine;

aliphatic and cyclic hydroxy-amines, e.g. ethanolamine, 2-methylaminoethanol, 2-(dimethylamino)ethanol, 2-(2-dimethylamino-ethoxy)-ethanol, diethanolamine, N-methyldiethanolamine, triethanolamine, 2-(2-aminoethyl-amino)-ethanol, triisopropanolamine, 2-amino-2-hydroxymethyl-1,3-propanediol, 1-piperidine-ethanol, 2-aminophenol, barbituric acid, 2-(4-aminophenoxy)-ethanol and 5-amino-1-naphthol.

The concentrates for processing colour negative films preferably comprise no or only small amounts of one or more water-soluble organic solvents.

Suitable lime prevention agents are, for example, aminopolycarboxylic acids, such as e.g. ethylenediaminetetraacetic acid (EDTA), propylenediaminetetraacetic acid (PDTA), β-alaninediacetic acid (ADA), diethylenetriaminepentaacetic acid (DTPA), methylimidodiacetic acid (MIDA), ethylenediaminemonosuccinate (EDMS), methylglycinediacetic acid (MGDA), ethylenediaminedisuccinate (EDDS), specifically (S,S)-EDDS, iminosuccinic acid, iminosuccinic acid-propionic acid and 2-hydroxypropyliminodiacetic acid.

Further suitable complexing agents for calcium and also for heavy metals are e.g. polyphosphates, phosphonic acids, polyaminopolyphosphonic acids, hydroxyalkylidenediphosphonic acids, aminopolyphosphonic acids and hydrolysed polymaleic anhydride, e.g. sodium hexametaphosphate, 1-hydroxyethane-1,1-diphosphonic acid, aminotrismethylenephosphonic acid, ethylenediaminetetramethylenephosphonic acid, 4,5-dihydroxy-1,3-benzenedisulfonic acid, 5,6-dihydroxy-1,2,4-benzenetrisulfonic acid, 3,4,5-trihydroxybenzoic acid, morpholinomethandiphosphonic acid and diethylenetriaminepentamethylenephosphonic acid.

The concentrates preferably comprise no undissolved constituents, and in particular are free from precipitation during storage, particularly preferably also during storage below 0° C., in particular between 0° C. and −7° C.

The concentrates employed can comprise a comparatively high content of water-miscible, in particular straight-chain organic solvents which carry hydroxyl groups and have a molecular weight of about 50 to 200, and a buffer substance soluble therein. The weight ratio of water to the organic solvent is preferably between 15:85 and 50:50.

The wetting agents employed in the concentrate can be anionic, cationic or nonionic. Nonionic wetting agents having polyalkylene oxide structural units are preferred.

The buffer substance preferably has a pKa value of between 9 and 13. Suitable buffer substances are e.g. carbonates, borates, tetraborates, salts of glycine, triethanolamine, diethanolamine, phosphates and hydroxybenzoates, of which alkali metal carbonates, alkali metal phosphates and triethanolamine are preferred and alkali metal carbonates, such as e.g. sodium carbonate and potassium carbonate, are particularly preferred.

In the preparation of low-sulfate concentrates which comprise the colour developer substance, an alkali metal base is added to an aqueous solution which contains the sulfate of the colour developer and optionally further additives, and the precipitation of alkali metal sulfate can then be brought to completion by addition of the organic solvent. The alkali metal sulfate is separated off by any desired suitable separating technique, e.g. by filtration.

Organic solvents which are particularly suitable for this purpose are e.g. polyols, and of these in particular glycols, such as ethylene glycol, diethylene glycol and triethylene glycol, polyhydroxyamines, and of these in particular polyalkanolamines, and alcohols, in particular ethanol and benzyl alcohols. The organic solvent which is most suitable for the preparation of one-phase one-component concentrates is diethylene glycol.

The processing conditions, suitable colour developer substances, suitable buffer substances, suitable lime prevention agents, suitable whiteners, auxiliary developers, development accelerators and anti-fogging agents are described in Research Disclosure 37 038 (February 1995) on pages 102 to 107 and 111 to 112.

The following processing sequences are particularly suitable:

Colour development, bleach-fixing, washing/stabilizing

Colour development, bleaching, fixing, washing/stabilizing

Colour development, bleaching, bleach-fixing, washing/stabilizing

Colour development, stopping, washing, bleaching, washing, fixing, washing/stabilizing

Colour development, bleach-fixing, fixing, washing/stabilizing

Colour development, bleaching, bleach-fixing, fixing, washing/stabilizing

The multi-chamber package for a colour developer replenishing solution can also include a third concentrate which comprises e.g. antioxidant, whitener with solvents or stabilizers.

The invention also provides a process for processing photographic materials, characterized in that a multi-chamber package is used for replenishing the processing chemicals.

The invention also provides a process for the production of a multi-chamber package, characterized in that the chambers of the package are produced in one piece by a plastics extrusion blow moulding process, the chambers are then filled with the various chemicals and the package is subsequently closed.

The invention also provides the use of the multi-chamber package for replenishing a processing tank or a replenisher tank of a photographic processing apparatus.

Further preferred embodiments of the present invention can be seen from the sub-claims.

### EXAMPLES

Procedure for the Processing Experiments

In the following Examples 3 to 5, 7 and 8, commercially available colour paper Agfa type 11 was processed, this being a photographic colour negative paper for fast processing which has a total silver content of approx. 0.6 g silver per m², the silver halide emulsions of which comprise silver chloride to the extent of more than 95 mol %. Processing was carried out in an Agfa minilab of the type MSC 101, the minilab being prepared as follows for each individual experiment.

The processing tanks (CD, BX, SB) of the initially completely emptied (processing and replenisher tanks) minilab were prepared with a batch from the commercially available Agfa MSC 101 Tank kit (process AP 94) and the replenisher tank for the developer and the stabilizing bath were prepared from the commercially available MSC 101 Paper CD-R and MSC 101 Paper SB-R. The replenisher tank for the bleach-fixing bath was filled as described in the examples.

To simulate a handling error by the operating staff, the batches in the bleach-fixing replenisher containers were not stirred. All the tank solutions and the remaining replenisher solutions were prepared according to type.

The replenishment rates in all the experiments were 90 ml/m² for the colour developer, 100 ml/m² for the bleach-fixing bath and 200 ml/m² for the stabilizing bath.

In order to bring the process into a state of equilibrium, in each case an amount of the colour paper, exposed with pictorial objects, was processed until 1 l of bleach-fixing bath replenisher was consumed. Thereafter, black sheets, that is to say sheets exposed over the entire area and in all colours up to the maximum density, were processed in order to evaluate the bleaching action. Black sheets are a suitable test material for a bleach-fixing bath, since on the sheets exposed in this way the entire amount of silver contained in the paper must be bleached after the development. The bleaching action can easily be checked visually on the completely processed sheets under IR light with an IR viewer since the material without residual silver is transparent to IR, while silver is non-transparent to IR. The observations of the test results are stated in the examples as “residual silver” if residual silver was observed or as “no residual silver” if the bleaching action was in order.

For the experiments according to the invention, a two-chamber bottle according to FIGS. 1 and 2 was used, and during pouring out the bottle was held such that the connecting bridge dividing the spout and the upper closing area (3) thereof were aligned horizontally.

### Example 1

In this experiment, the thorough mixing in the replenisher container of the Agfa MSC 101 minilab was investigated. For this, as preparation, in each case it was merely necessary to empty the replenisher container for the bleach-fixing solution. No processing was carried out.

1 litre of concentrate component A comprises
700 ml ammonium thiosulfate solution, 58 wt. % strength
100 g sodium disulfite
pH 5.5
The pH is adjusted with NH₃ or H₂SO₄.

1 litre of concentrate component B comprises
700 ml NH₄Fe(III)EDTA solution, 48 wt. % strength
pH 7.0
The pH is adjusted with NH₃ or H₂SO₄.

200 ml of component A and 100 ml of component B are required for the preparation of 1 litre of ready-to-use bleach-fixing replenisher solution.

Two 5 litre batches were prepared with the above concentrates in the previously in each case completely emptied bleach-fixing replenisher container of an Agfa MSC 101 minilab. For this, in each case 3.5 litres of water were initially introduced and the concentrates component A and component B
in the first experiment a) were added in succession (first component A, then component B) from a 1,000 ml bottle and a 500 ml bottle and
in the second experiment b) were added simultaneously from a two-chamber bottle with a removal opening,
   wherein in experiment b) the concentrates come into contact directly after the removal opening and the chambers have a volume of approx. 1,000 ml and approx. 500 ml.

To simulate a handling error by the operating staff, the batches in the bleach-fixing replenisher container were not stirred. Samples were taken from the two batches at various heights of the replenisher container and analysed for the content of thiosulfate and iron. The results are shown in Table 1.

TABLE 1

| | | a) | b) |
|---|---|---|---|
| | | Comparison | Invention |
| | | 2 individual | two-chamber |
| Constituent analysed | Sampling point | bottles | bottle |
| Ammonium thiosulfate | top | 27.4 g/l | 74.2 g/l |
| | middle | 143.0 g/l | 114.0 g/l |
| | bottom | 81.6 g/l | 117.0 g/l |
| NH₄Fe(III)EDTA | top | 5.4 g/l | 31.5 g/l |
| | middle | 30.6 g/l | 46.8 g/l |
| | bottom | 129.0 g/l | 48.3 g/l |

It can be clearly seen from the results that, surprisingly, a considerably better thorough mixing of the batch takes place due to the simultaneous flowing in of the two concentrates from a two-chamber bottle than when two individual bottles are used.

### Example 2

Concentrate component A corresponding to Example 1

1 litre of concentrate component B comprises
350 ml NH₄Fe(III)EDTA solution, 48 wt. % strength
40 g succinic acid
pH 3.0
The pH is adjusted with HNO₃.

200 ml of component A and 200 ml of component B are required for the preparation of 1 litre of ready-to-use bleach-fixing replenisher solution.

The experiments and analyses are carried out analogously to Example 1, with the difference that for each experiment in each case 3 litres of water are initially introduced and the concentrates component A and component B
in the first experiment a) are added in succession from two 1,000 ml bottles and
in the second experiment b) are added simultaneously from a two-chamber bottle,

wherein the chambers of the two-chamber bottle each have a volume of approx. 1,000 ml. The results are shown in Table 2.

TABLE 2

| | | a) | b) |
|---|---|---|---|
| | Sampling | 2 individual | Two-chamber |
| Constituent analysed | point | bottles | bottle |
| Ammonium thiosulfate | top | 29.1 g/l | 73.7 g/l |
| | middle | 139.0 g/l | 115.0 g/l |
| | bottom | 85.3 g/l | 117.0 g/l |
| NH₄Fe(III)EDTA | top | 5.8 g/l | 31.3 g/l |
| | middle | 33.2 g/l | 47.6 g/l |
| | bottom | 126.0 g/l | 48.9 g/l |

It can be clearly seen from the results that, surprisingly, a considerably better thorough mixing of the batch takes place due to the simultaneous flowing in of the two concentrates, even in the case of a two-chamber bottle with chambers of equal volume, than when two individual bottles of the same volume are used.

### Example 3

In order to investigate the influence of the thorough mixing on the processed material, experiments a) and b) from Example 1 were repeated, but this time as described under “Procedure for the processing experiments”.

The results are shown in Tab. 3.

TABLE 3

| | Comparison | |
|---|---|---|
| | a) from 1,000 and 500 ml | Invention |
| Paper throughput | bottle | b) from two-chamber bottle |
| 10 m² | no residual silver | no residual silver |
| 20 m² | no residual silver | no residual silver |
| 30 m² | no residual silver | no residual silver |
| 40 m² | residual silver | no residual silver |
| 50 m² | residual silver | no residual silver |

It can be clearly seen from Table 3 that in the course of processing of the paper residual silver occurs if the replenisher is prepared from the 2 bottles conventionally used, while this problem surprisingly does not occur if the two-chamber bottle according to the invention is used.

### Example 4

The concentrates component A and component B prepared in Example 1 were bottled in
a) two individual bottles and
b) in a two-chamber bottle and stored for 4 weeks at 40° C.

Tank solutions were then prepared from the concentrates by filling up
a) 2 l of component A and 1 l of component B from the individual bottles or
b) 2 l of component A and 1 l of component B from the two-chamber bottle to 10 litres, adjusting the solutions to a pH of 6.0 with ammonia and filling an MSC 101 apparatus with them. The remaining baths were prepared as described under “Procedure for the processing experiments”. Type 11 paper was then processed and measured sensitometrically.

It was found here that on processing of type 11 paper, different yellow foggings (Yw-Dₘᵢₙ) were generated. The tank solution from the BX concentrates of the two-chamber bottle showed a lower yellow fogging on the developed paper than when the tank solution from the two individual bottles was used. The measurement results are reproduced in Table 4.

TABLE 4

| | Comparison | Invention |
|---|---|---|
| Package | two individual bottles | two-chamber bottle |
| Yw-Dₘᵢₙ × 1,000 | 112 | 103 |

It can be clearly seen from Table 4 that when the tank solution from the two individual bottles is used, a high yellow fogging occurs after processing, while this problem surprisingly does not occur when the two-chamber bottle is used.

### Example 5

The paper materials processed in Example 4 were stored for 32 days at 35° C., 90% relative humidity after the processing and the yellow fogging was then measured again. The results are reproduced in Table 5.

TABLE 5

| | Comparison | Invention |
|---|---|---|
| Package | two individual bottles | two-chamber bottle |
| Yw-Dₘᵢₙ × 1,000 | 176 | 141 |

It can be clearly seen from Table 5 that when the tank solution from the two individual bottles is used, the yellow fogging is increased significantly after processing and storage in a climate, compared with the fresh development, while this problem surprisingly occurs to a substantially lower degree when the two-chamber bottle is used.

### Example 6

Concentrates were prepared for

a) a one-component bleach-fixing bath and
b) a two-chamber bleach-fixing bath,

which were to be used for preparation of in each case 10 l of replenisher. For the concentrate of the two-chamber bleach-fixing bath, a 2 times 1 l bottle was used, and for the one-component bleach-fixing bath concentrate a 2 l bottle. For preparation of the replenishers, in each case 2 times 100 ml of the two-chamber bleach-fixing bath or 200 ml of the one-component bleach-fixing bath were used, so that after preparation from the two concentrates the replenisher contained the same concentration of the active compounds employed.
a) Recipe for a one-component bleach-fixing bath:

1 litre of concentrate comprises
350 ml ammonium thiosulfate solution, 58 wt. % strength
50 g sodium disulfite
   NH₄Fe(III)EDTA solution 48 wt. % strength, corresponding to Table 6
10 g succinic acid
pH 5.7
The pH is adjusted with NH₃ or H₂SO₄.
b) Recipe for a two-chamber bleach-fixing bath:

1 litre of concentrate component A comprises
700 ml ammonium thiosulfate solution, 58 wt. % strength
100 g sodium disulfite
pH 5.3
The pH is adjusted with NH₃ or H₂SO₄.

1 litre of concentrate component B comprises
NH₄Fe(III)EDTA solution 48 wt. % strength, corresponding to Table 6
20 g succinic acid
pH 6.5
The pH is adjusted with NH₃ or H₂SO₄.

To simulate cold and hot storage during transportation to the customer and at the customer's premises, the concentrates prepared under a) and b) were stored first for one week at 60° C. and then for one week at −5° C. The samples were then investigated visually for precipitates in the concentrate. The results are shown in Table 6.

TABLE 6
Content of NH₄FeEDTA (g/l)

| | Concentrate | | Result | |
|---|---|---|---|---|
| | Comparison | Invention | Comparison | Invention |
| | one-compo- | 2-chamber | one-compo- | 2-chamber |
| Replenisher | nent BX | BX | nent BX | BX |
| 36 | 180 | 360 | precipitates | no precipitates |
| 34 | 170 | 340 | precipitates | no precipitates |
| 32 | 160 | 320 | precipitates | no precipitates |
| 30 | 140 | 280 | precipitates | no precipitates |
| 28 | 140 | 280 | precipitates | no precipitates |

As can be clearly seen from Table 6, after storage of the concentrates precipitates occur in all the concentrates of the one-component bleach-fixing bath in spite of a reduced concentration of NH₄Fe(III)EDTA, while, surprisingly, this is not the case in the two-chamber bottle, in spite of the concentration of NH₄Fe(III)EDTA in each case being twice as high.

### Example 7

The concentrates prepared under a) and b) in Example 6 were stored for 1 week at 60° C. Tank solutions were then prepared from the concentrates by filling up
a) 2 l of the one-component concentrate or
b) 1 l of component A and 1 l of component B of the two-chamber concentrate from a two-chamber bottle

in each case to 10 litres, adjusting the solutions to a pH of 6.0 with ammonia and mixing them thoroughly. The experiments were in each case carried out as described under “Procedure for the processing experiments”.

It was found here that on processing with the replenisher tank solution prepared from the one-component BX concentrate, residual silver clearly occurred in the paper, while, surprisingly, when the tank solution prepared from the two-chamber concentrate was used, no residual silver at all was to be observed, and that the differences are also significant when the BX replenisher solution is thoroughly mixed.

### Example 8

Experiments a) and b) from Example 7 were repeated, but with the difference that the pH values of the replenishers were adjusted to 5.0.

The Agfa MSC 101 minilab was then prepared as described under “Procedure for the processing experiments”.

However, no black sheets were processed, but in each case 350 m² of colour paper Agfa type 11 exposed with conventional image objects.

To simulate conditions in practice during processing of the paper, a high throughput of at least 50 m² colour paper per day was furthermore processed. At the end of each day, the occurrence of residual silver by processing of a black sheet was tested visually with IR spectacles. The result is shown in Table 7.

TABLE 7

| | Comparison | Invention |
|---|---|---|
| Paper | a) from one-component | b) from two-chamber |
| throughput | BX concentrate | bottle |
| 1 day | no residual silver | no residual silver |
| 2 days | no residual silver | no residual silver |
| 3 days | no residual silver | no residual silver |
| 4 days | residual silver | no residual silver |
| 5 days | residual silver | no residual silver |
| 6 days | residual silver | no residual silver |
| 7 days | residual silver | no residual silver |

As Table 7 clearly shows, at a high throughput of paper residual silver occurs after approx. 4 days with the replenisher prepared from the one-component bleach-fixing bath, while, surprisingly, no residual silver is formed over the entire test duration with the replenisher prepared from the two-chamber bottle.

### Example 9

Concentrates were prepared for
a) a one-component bleach-fixing bath and

b) a two-chamber bleach-fixing bath.

a) Recipe for a one-component bleach-fixing bath:

| 1 litre of concentrate comprises: | |
|---|---|
| Ammonium thiosulfate solution, 58 wt. % | 350 ml |
| Potassium sulfite | 100 g |
| NH₄Fe(III)EDTA solution, 48 wt. % | 140 g |
| Succinic acid | 10 g |
| pH | 5.7 |

The pH is adjusted with NH₃ or H₂SO₄.

b) Recipe for a two-chamber bleach-fixing bath:

| 1 litre of concentrate component A comprises | |
|---|---|
| Ammonium thiosulfate solution, 58 wt. % | 700 ml |
| Potassium sulfite | 200 g |
| pH | 5.5 |

The pH is adjusted with NH₃ or H₂SO₄.

| 1 litre of concentrate component B comprises | |
|---|---|
| NH₄Fe(III)EDTA solution, 48 wt. % | 280 g |
| Succinic acid | 20 g |
| pH | 6.0 |

The pH is adjusted with NH₃ or H₂SO₄.

The concentrates prepared under a) and b) were stored for 6 weeks at 40° C. The sulfite content was determined analytically here in the fresh state and after storage. The result is shown in Table 8.

TABLE 8
Content of potassium sulfite (g/l)

Concentrate

| | Comparison | Invention |
|---|---|---|
| | one-component BX | 2-chamber BX |
| fresh | 100 | 200 |
| after storage for 6 w | 68 | 196 |
| 40° C. | | |

After storage of the concentrates, replenishers were prepared from the concentrates by filling up in each case 2×1 l of component A and B of the two-chamber concentrate or 2 l of the one-component concentrate to 10 litres. The replenishers were then stored at room temperature for 5 weeks. During the storage, the sulfite content was determined at regular intervals of time and the replenisher was investigated visually for sulfur precipitates.

The result is shown in Table 9.

TABLE 9
Content of potassium sulfite (g/l)

| | Replenisher | | Result | |
|---|---|---|---|---|
| | Comparison | Invention | Comparison | Invention |
| | one-component | 2-chamber | one-component | 2-chamber |
| | BX | BX | BX | BX |
| fresh | 13.6 | 19.1 | no precipitates | no precipitates |
| 1 week | 7.5 | 14.4 | no precipitates | no precipitates |
| 2 weeks | 5.5 | 9.3 | no precipitates | no precipitates |
| 3 weeks | 2.1 | 6.7 | no precipitates | no precipitates |
| 4 weeks | 0.5 | 3.6 | precipitates | no precipitates |
| 5 weeks | 0.4 | 2.1 | precipitates | no precipitates |

As Table 9 shows, after a standing time of approx. 4 weeks at room temperature, precipitates occur with the replenisher prepared from the one-component bleach-fixing bath, while in the replenisher prepared from the two-chamber bottle no precipitates are observed over the entire test period. The occurrence of precipitates in the replenisher prepared from the one-component bleach-fixing bath can lead to blockages of the replenisher pumps and to silver sulfide precipitates in the tank solution, as a result of which a loss of production is caused for the minilab operator and complete cleaning of the minilab wet component becomes necessary.

1. Package for storing photographic processing chemicals and for filling a tank of a processing apparatus with the processing chemicals, the package containing at least two different chemicals spatially separated in chambers, characterized in that the chemicals belong to the same processing step and the package is constructed such that said different chemicals are brought into contact with one another within the package before the tank is filled with them and/or are brought into contact with one another while the tank is filled with them.

2. Package according to claim 1, characterized in that said different chemicals are brought into contact with one another within the package while the tank is filled with them.

3. Package according to claim 1, characterized in that said different chemicals are brought into contact directly at the removal opening while the tank is filled with them.

4. Package according to claim 1, characterized in that at least two chambers have a common closable removal opening.

5. Package according to claim 4, characterized in that all the chambers have a common closable removal opening.

6. Package according to claim 1, characterized in that at least two chambers have separate openings which are connected to a removal opening with an adapter.

7. Package according to one of claim 1, characterized in that the package has only one closure, which closes all the chambers.

8. Package according to claim 7, characterized in that the closure is a screw closure.

9. Packaging according to claim 1, characterized in that at least one removal opening is sealed with a film or sealed off with a sealing ring.

10. Package according to claim 1, characterized in that it is made of plastic.

11. Package according to one claim 1, characterized in that it contains the chemicals for a two- or multi-component bleach-fixing bath concentrate.

12. Packaging according to claim 11, characterized in that it contains the bleaching agent and the fixing agent in separate chambers.

13. Package according to claim 11, characterized in that it comprises as the bleaching agent at least one iron complex with one of the complexing agents ethylenediaminetetraacetic acid (EDTA), propylenediaminetetraacetic acid (PDTA), β-alaninediacetic acid (ADA), diethylenetriaminepentaacetic acid (DTPA), methyliminodiacetic acid (MIDA), ethylenediaminemonosuccinate (EDMS), methylglycinediacetic acid (MGDA), ethylenediaminedisuccinate (EDDS), iminosuccinic acid, iminosuccinic acid-propionic acid or 2-hydroxypropyliminodiacetic acid.

14. Package according to claim 11, characterized in that it contains ammonium thiosulfate as the fixing agent.

15. Package according to claim 11, characterized in that it contains a buffer substance in the chamber with the bleaching agent and/or in the chamber with the fixing agent.

16. Process for processing photographic materials, characterized in that a package according to claim 1 is used for replenishing the processing chemicals.

17. Process for the production of the package according to claim 1, characterized in that the chambers of the package are produced in one piece by a plastics extrusion blow moulding process, the chambers are then filled with the various chemicals and the package is subsequently closed.

18. Use of the package according to claim 1 for replenishing a processing tank or a replenisher tank of a photographic processing apparatus.
